(19) United States
(12) Patent Application Publication
(10) Pub. No.: US 2017/0172177 A1
(43) Pub. Date: Jun. 22, 2017

(54) METHOD FOR PRODUCING A MEAT-BASED ANIMAL FEED CONCENTRATE, MEAT-BASED ANIMAL FEED CONCENTRATE AND MEAT-BASED ANIMIAL DRINK

(71) Applicant: Hans-Juergen DEUERER, Bretten (DE)

(72) Inventor: Hans-Juergen DEUERER, Bretten (DE)

(21) Appl. No.: 15/310,119

(22) PCT Filed: May 19, 2015
(86) PCT No.: PCT/EP2015/060982

§ 371 Date: Nov. 10, 2016

(30) Foreign Application Priority Data
May 19, 2014 (DE) 10 2014 107 054.2

(51) Int. Cl. A23K 50/42; A23K 10/28; A23K 10/30; A23K 10/35; A23K 40/25; A23K 20/158; A23K 20/163; A23K 20/179; A23K 40/00; A23K 40/10; A23K 10/20; A23K 20/10

(52) U.S. Cl. CPC A23K 50/42; A23K 10/20; A23K 10/28; A23K 10/30; A23K 10/35; A23K 20/10; A23K 20/158; A23K 20/163; A23K 20/179; A23K 40/00; A23K 40/10; A23K 40/25

(57) ABSTRACT

The invention relates to a method for producing a meat-based animal feed concentrate. The invention also relates to a meat-based animal feed concentrate which can be obtained according to the claimed method, to a meat-based animal drink, to the use of the meat-based animal drink for carnivorous household pets and to a packaging unit for the meat-based animal feed concentrate and/or the meat-based animal drink.

The invention relates to a method for producing a meat-based animal feed concentrate. The invention further relates to a meat-based animal feed concentrate obtainable by the method according to the invention, a meat-based animal drink, use of the meat-based animal drink as feed for carnivorous pets, and a packaging unit for the meat-based animal feed concentrate and/or the meat-based animal drink.

Carnivores such as dogs and cats, which are kept as pets, are often not fed a species-appropriate diet.

In nature, these animal species chiefly feed on prey, i.e., they consume animal proteins in the form of meat.

In preparing feed products for carnivorous animals, it is nutritionally appropriate to provide a high protein content with a simultaneously low carbohydrate content.

In addition to feed given as the main meal in the form of dry, semi-moist, or moist feed, there is also increasing consumer demand for snacks or supplementary feed products to be used for selective enhancement of the main feed product.

Carnivorous animals not fed a species-appropriate diet have problems such as increased susceptibility to metabolic diseases. Carnivorous animals should therefore be given feed that is nutritionally suitable and similar to natural meat feed.

Accordingly, it is preferably to provide animal feed that can be given, for example, in order to selectively enhance the regular feed, or in particular cases, e.g. in the case of particular pet diseases, can be given as the sole animal feed.

Situations are also conceivable in which, in addition to optimum nutritional intake, the focus also lies on optimization of daily water intake, chiefly via water. Moreover, it can be advisable-particularly in countries with highly chlorinated water-to provide an animal feed which, instead of water, can be mixed with other liquids, e.g. milk for cats or the like, in order to increase the acceptance of the animal feed while simultaneously providing the animal with liquid via said animal feed.

The object is achieved by a method for producing a meat-based animal feed concentrate, wherein
a. a cutter for producing an animal feed precursor is charged with at least the following ingredients, which have a temperature equal to or lower than +25° C.: at least one component of the meat group,
b. the ingredients are minced to form a feed precursor with a moisture content of 30 wt % to 60 wt %,
c. optionally, the feed precursor is dried until a moisture content of 5 wt % to 40 wt % is reached,
d. the optionally dried feed precursor is crushed into particles between 0.5 mm and 5 mm in size, and
e. the particles of the dried feed precursor are mixed with one or a plurality of thickeners, particularly selected from the group of guar gum, carboxymethylcellulose, xanthan, carrageenan, and starch and the meat-based animal feed concentrate is thus obtained.

In an embodiment, the feed precursor according to step b.) is shaped after mincing and before step c.), e.g. by extrusion.

Surprisingly, it was found that the method according to the invention provides an animal feed concentrate which, after the addition of liquids such as water, cow's milk, and so-called milk for cats-i.e. a product intended for cats-can be developed into an animal drink that is particularly well-accepted by carnivorous pets.

A meat-based animal feed concentrate is understood to mean an animal feed concentrate having a content of at least 30 wt % meat relative to the total weight of the feed precursor or the animal feed concentrate.

“Meat” is understood to refer to all meat parts of slaughtered warm-blooded land animals, fresh or preserved by a suitable method, and all products of processing of the bodies of land animals that are allowed in animal feed processing.

In an advantageous embodiment, the meat content of the feed precursor is between 30 wt % and 95 wt %, preferably between 40 wt % and 80 wt %, and more preferably between 60 wt % and 70 wt %. This embodiment is advantageous in that the meat-based animal drink or the prepared meat-based animal feed concentrate is consumed by animals particularly readily, wherein acceptance further increases with increasing meat content.

In an advantageous embodiment, the ingredients for producing the feed precursor have a temperature in the range of −18° C. to +7° C. This embodiment is advantageous in that the mincing time required until the protein contained in the precursor disintegrates and a bonded feed precursor is produced is only approximately 5 to 15 minutes, e.g. approximately 5 to 10 minutes. Accordingly, the method is particularly economical with respect to the required expenditure of time and energy. By means of mincing, this embodiment provides an animal feed precursor whose temperature is up to approximately 15° C.

“Cutter” and “mincing” are understood in the present invention to mean that the components contained in the cutter are finely and minutely crushed. This means that the particle size distribution is in the range of 10 mm to 0.1 mm or smaller. Mincing is characterized by a process in which the cell membranes of as many cells as possible are damaged so as to obtain a fine, homogeneous mass. Corresponding “cutters” are known to the person skilled in the art. In this process, the blades are used at a speed of at least 60 rpm, for example at least 200 rpm, e.g. at least 2860 rpm. This causes at least partial denaturing of the proteins during mincing.

In a further advantageous embodiment, additional cooling is carried out, for example by adding ice or cooling the cutter by means of cooling elements, so that a maximum temperature of approximately 5° C. is reached. At a maximum temperature of the produced feed precursor of approximately 5° C., the texture of said processor is particularly homogenous.

The moisture content of the feed precursor can advantageously be 40 wt % to 50 wt % or 50 wt % to 60 wt %, e.g. 54-60 wt %. The advantage of using a feed precursor with this moisture content of 40 wt % to 50 wt % is that—if drying is necessary—the drying step can be kept short, so that the nutrients in the predominantly meat-based animal feed can be retained to the greatest extent possible.

If the feed precursor is shaped, this can take place by extrusion—i.e. by a thermal process in which the components of the product are decomposed by sudden evaporation of the water contained in the product and are given a particular form by simultaneously being forced through a nozzle.

In principle, shaping of the feed precursor can also be carried out by non-thermal means, in which case the feed precursor should then pass through a steam tunnel.

In a further advantageous embodiment, drying of the optionally shaped feed precursor until a moisture content of 5 wt % to 40 wt % is reached is advantageously carried out at a temperature in the range of 50° C. to 200° C. In the temperature range of 50° C. to 200° C., there is a favorable relationship between the time required to reach a moisture content of 5 wt % to 40 wt % and the energy required for drying.

Drying of the optionally shaped feed precursor until a moisture content of 5 wt % to 40 wt % is reached can advantageously be carried out in a temperature range of 80° C. to 90° C. Surprisingly, it was found that in this temperature range, the relationship between economically advantageous drying and the nutrient content of the semi-moist animal feed product according to the invention is the most favorable.

For example, the optionally shaped feed precursor can be dried to a moisture content of approximately 10 wt % to 25 wt %, and particularly approximately 12 wt %. The subsequent grinding process in the method according to the invention provides a particularly homogenous grinding result at a moisture content of the optionally shaped feed precursor of approximately 12 wt %.

In a further advantageous embodiment, the ingredients for producing the feed precursor are used in completely or partially frozen form. Surprisingly, it was found in this case that when one or a plurality of thickeners are added to such a feed precursor, the required mixing times are extremely short, making this particularly economical.

In a further advantageous embodiment, the ingredients for producing the feed precursor are crushed before charging of the cutter by feeding them through one or a plurality of perforated disks. It has been found in this case that crushing before the mincing process provides a more homogenous feed precursor, and as a result, the mincing process does not have to be excessively prolonged, so that the animal proteins are retained as favorably as possible.

In a further advantageous embodiment, vegetables and/or cereal and/or potatoes and/or glycerol are added to the ingredients for producing the feed precursor before mincing. These further feed components provide better technical processing of the feed, in the sense that the feed precursor is easier to process because it is less tacky. Surprisingly, it was found that the tackiness of the feed precursor can be reduced by adding the above-mentioned further feed components to the ingredients for producing the feed precursor before the mincing process.

In a further advantageous embodiment, additives commonly used in the animal feed industry are added. In particular, these are flavoring agents, natural or synthetic dyes, inactivated yeasts or yeast extracts, plant extracts and/or concentrates, preservatives, sugars, and/or functional ingredients. Functional ingredients are understood, for example, to be probiotics, but also vitamins, minerals, omega-3 fatty acids, probiotic dietary fiber, and probiotic microorganisms.

In the method, preservatives such as potassium sorbate can be used. For example, potassium sorbate can be used in a concentration of 0.1 wt % to 1 wt % relative to the total weight of the feed precursor. The addition of potassium sorbate in an amount of approximately 0.5 wt % relative to the total weight of the feed precursor results in a minimum shelf life of the meat-based animal feed concentrate according to the invention of approximately 15 to 18 months.

Advantageously, there is no need to use binders such as carrageenan, gelatin, agar agar, or pectin. Nor do dairy products or their proteins need to be used. This is advantageous with respect to possible intolerance to dairy products or milk protein.

In the method, the meat-based animal feed concentrate can advantageously be blended with a mixture of meat-and-bone meal and sweet whey powder that is sprayed with fat such as poultry fat. The advantage of this embodiment is that a particular flavor is achieved, which then results in particularly high acceptance of the animal drink or the animal feed concentrate, mixed e.g. with a liquid.

The meat-based animal feed concentrate according to the invention is obtainable by the method according to the invention.

The meat-based animal drink according to the invention is obtainable by mixing of the animal feed concentrate produced according to the invention with liquids such as water or milk, particularly cow's milk and so-called milk for cats—i.e. a product intended for cats.

The meat-based animal drink can have a smooth or creamy consistency. It was found that animals—regardless of their species—can react differently with respect to the acceptable consistency of the meat-based animal drink.

The meat-based animal drink according to the invention advantageously has a pH of between 5 and 6.5. Animal feeds with this pH are especially suitable for carnivorous animals, particularly from a microbiological and nutritional standpoint.

According to the invention, the meat-based animal drink of the invention is used as feed, such as complete animal feed or snacks, for carnivorous pets such as dogs or cats.

According to the invention, moreover, a packaging unit for a meat-based animal feed concentrate according to the invention and/or a meat-based animal drink according to the invention is/are provided, wherein the packaging unit contains an animal feed for carnivorous pets, such as dry feed, within a package volume together with the meat-based animal feed concentrate according to the invention and/or the meat-based animal drink according to the invention, or separately in an additional compartment of the packaging.

With the method described above, a new meat-based animal feed concentrate can be obtained that consists exclusively of meat, for example dried meat—optionally ground into meal—to at least 30 wt %, preferably between 30 wt % and 95 wt %, and more preferably between 40 wt % and 80 wt %, for example between 60 wt % and 70 wt % relative to the total weight of the feed precursor.

The meat-based animal feed concentrate according to the invention can be colored with dyes. It has been shown that this measure increases the acceptance of the product by the animal owner.

In the following, the invention is described in further detail with respect to an illustrative embodiment that serves only to explain a possible embodiment and by no means limits the scope of the invention.

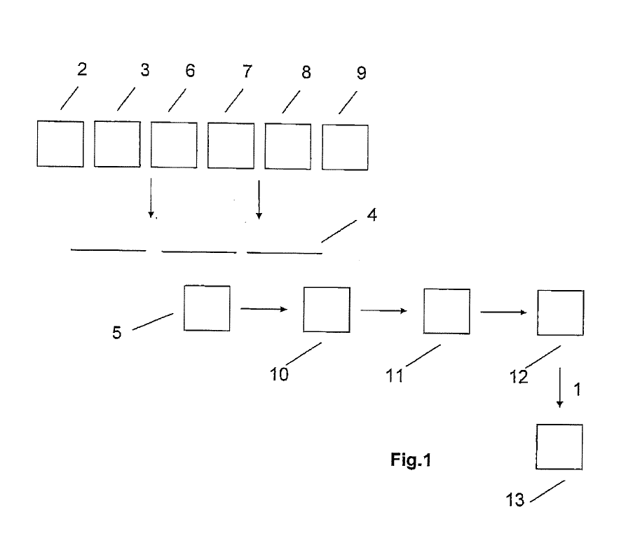

FIG. 1, which is the only figure, shows a schematic diagram for producing a meat-based animal feed concentrate according Lo the invention. First, the ingredients of the group “meat” are placed in the cutter 5. These ingredients are located in containers 2 and optionally 3 (if separate containers, e.g. for meat of different animal species, are provided) and are conveyed from there to the cutter 5. There are also further containers for vegetables 6 or cereal 7 or potatoes 8 or glycerol 9, which can be added to the meat-based ingredients. 4 denotes perforated disks that are upstream from the cutter 5 and are used to crush at least the flesh-based products for producing the feed precursor. After mincing in the cutter 5, the feed precursor is sent to an extruder 10 for extrusion. From the extruder 10, the shaped feed precursor is fed into a dryer, denoted by 11. A mill 12 is connected thereto, which for example grinds the extruded dried feed precursor into particles with an average size of 0.5 mm to 5 mm. For example, by means of a tube (not shown in FIG. 1), thickeners are supplied to the particulate dried feed precursor from a further container (also not shown in FIG. 1). The final product, i.e. the meat-based animal feed concentrate 1, is sent on to processing and/or packaging units, denoted here collectively by 13.

1. A method for producing a meat-based animal feed concentrate, comprising the steps of:
a) a cutter for producing an animal feed precursor with ingredients comprising at least one meat having a temperature equal to or lower than +25° C.,
b) mincing the ingredients to form an animal feed precursor with a moisture content of between 30 wt % and 60 wt %,
c) optionally, drying the feed precursor until a moisture content of 5 wt % to 40 wt % is reached,
d) crushing the optionally dried feed precursor into particles having a size between 0.5 mm and 5 mm, and
e) mixing the particles of the optionally dried feed precursor with one or a plurality of thickeners, selected from the group consisting of guar gum, carboxymethylcellulose, xanthan, carrageenan, and starch, thus obtaining the meat-based animal feed concentrate.

2. The method according to claim 1, wherein after the mincing according to step b and before the optional drying according to step c, the feed precursor is optionally shaped by extrusion.

3. The method according to claims 1, wherein the ingredients are in a completely or partially frozen form.

4. The method according to claim 1, wherein the ingredients, before being supplied to the cutter, are crushed by feeding them through one or a plurality of perforated disks.

5. The method according to claim 1, wherein at least one of vegetables, cereal, potatoes and glycerol are added to the ingredients before mincing.

6. The method according to claim 1, wherein at least one additive selected from the group consisting of flavoring agents, natural or synthetic dyes, inactivated yeast or yeast extracts, plant extracts and/or concentrates, preservatives, sugars, and functional ingredients is added to the ingredients.

7. The method according to claim 1, further comprising the step of blending the meat-based animal feed concentrate with a mixture of meat-and-bone meal and sweet whey powder, wherein said mixture is sprayed with fat.

8. A meat-based animal feed concentrate obtainable by the method of claim 1.

9. A meat-based animal drink obtainable by mixing of the meat-based animal feed concentrate produced according to claim 1 with a liquid.

10. The meat-based animal drink according to claim 9, wherein the liquid is water or milk.

11. The meat-based animal drink according to claim 9, wherein the liquid has a pH between 5.0 and 6.5.

12. A method for feeding a carnivorous pet comprising the step of providing to said pet the meat-based animal drink according claims 9.

13. The method according to claim 12, wherein the animal feed is configured as a complete animal feed or snack.

14. The method according to claim 12, wherein said carnivorous pet is a dog or cat.

15. A packaging unit for a meat-based animal feed concentrate according to claim 8 and/or a meat-based animal drink according to claim 9, wherein the packaging unit contains an animal feed for carnivorous pets within a package volume together with the meat-based animal feed concentrate and/or the meat-based animal drink, or separately in an additional compartment of the packaging.

16. The method of claim 7, wherein said fat is poultry fat.

17. The packaging unit of claim 15, wherein said animal feed for carnivourous pets is dry feed.
